(19) United States
(12) Patent Application Publication
(10) Pub. No.: US 2011/0260030 A1
(43) Pub. Date: Oct. 27, 2011

(54) Improved Device for Fixing an Antenna to a Supporting Surface and Method for Assembling an Antenna by Means of Said Fixing Device

(75) Inventors: Alessio Calearo, Costabissara (IT); Massimo Calearo Ciman, Costabissara (IT); Rudy Piccolo, Castegnero (IT)

(73) Assignee: CALEARO ANTENNE S.P.A., Milano (IT)

(21) Appl. No.: 12/919,404

(22) PCT Filed: Jan. 18, 2010
(86) PCT No.: PCT/EP2010/050545

§ 371 Date: Nov. 29, 2010

(30) Foreign Application Priority Data
Jan. 20, 2009 (IT) VI2009A000005

(51) Int. Cl. H01Q 1/12; H01P 11/00

(52) U.S. Cl. 248/534; 29/600

(57) ABSTRACT

The invention is a device (1) for fixing an antenna to a supporting surface (S), comprising a base plate (2) arranged against the supporting surface (S) and a fixing element (3) that communicates with an underlying opening (5) made in the supporting surface (S). In this fixing device the fixing element (3) is provided with a first and a second set of projecting elastic tabs (8, 9) suited to lock the base plate (2) to the supporting surface (S), through the thrusting action of the first set of elastic tabs (8) against the wall (10) of the supporting surface (S) and the insertion of the second set of elastic tabs (9) in a plurality of recesses (12) present on the edge of the opening (5) when the first and second set of elastic tabs (8, 9) are positioned in the opening (5) through the insertion and the successive shifting of the base plate (2) with respect to the supporting surface (S).

The present invention concerns a fixing device particularly suitable for fixing an antenna to a supporting surface that is often constituted by the body of a motor vehicle.

The present invention also concerns a method for assembling the above mentioned antenna on a supporting surface by means of the fixing device that is the subject of the invention.

It is known that motor vehicles are usually equipped with an antenna for receiving and transmitting radiofrequency signals for applications like radio station broadcasting activities, mobile telephony or other applications.

Said antennas can be arranged on various points of the motor vehicle but in most cases they are positioned on the roof of the motor vehicle, to which they are attached via fixing means.

The latter are usually constituted by a base plate, on which the antenna rests, said plate being attached to the body of the vehicle by means of one or more screws.

During installation the base plate is positioned on the body of the vehicle, at the height of the opening through which the screw must pass, and is held in this position until the screw is tightened.

This embodiment clearly evidences the acknowledged drawback constituted by the fact that the operation needed to install the antenna cannot be carried out comfortably, since the installer must keep it in place while tightening the screw. In order to overcome the drawback described above, various embodiments of devices for fixing antennas have been carried out, all characterized in that they comprise a shaped elastic body that fits in a through opening present on the body of the vehicle.

In particular, document EP 1 792 361 describes a fixing device for antennas consisting of a base plate provided with a projecting element that is inserted in the opening made in the roof of the motor vehicle.

The fixing device is also provided with a fixing element comprising at least two side wings which are inserted in special cavities created in said projecting element.

Said fixing element is provided on each side wing with elastic tabs that are bent according to longitudinal development axes which are divergent from and incident on the inner surface of the vehicle's roof, wherein said tabs are compressed when the antenna is inserted in the roof opening and return to their original position once they are beyond the opening, in such a way as to prevent the base plate from coming off.

A further document describing a fixing device for antennas is the patent application US 2004/183734.

Also in this case, the above mentioned fixing device consists of a base plate provided with a projecting element that is inserted in the opening made in the roof of the motor vehicle.

Differently from the previous case, the above mentioned fixing device comprises also a washer-shaped element connected to said projecting element and comprising two types of elastic tabs.

The first type of tab makes it possible to lock the washer-shaped element onto the base plate of the fixing device, while the second type of tab opposes the internal surface of the vehicle's roof in order to carry out a pre-fixing operation.

Finally, document EP 1 585 185 describes a fixing device for antennas comprising a base plate to which a fixing element is applied, said fixing element having the shape of a parallelepiped made up of only one type of elastic tab on all its four sides.

The three types of fixing device described in the documents mentioned above all pose considerable drawbacks that are listed here below.

A first drawback lies in that the elastic tabs that are present in the three types of fixing device described above serve only to pre-fix the antenna, which is successively fixed permanently from the inside, by means of a nut or screw.

In particular, concerning the fixing device described in document EP 1 585 185, the antenna may not be fixed in a stable and definitive manner due to the fact that there may be some play between the elastic tabs of the fixing element and the internal surface of the roof.

Another important drawback due to the fact that the elastic tabs do not guarantee a stable and continuous contact with the roof is represented by the fact that the electrical continuity between the antenna and the vehicle's roof isn't optimal.

A further drawback that is more evident in the first two fixing devices described above lies in that the elastic tabs cannot prevent the rotation of the fixing device and consequently of the antenna in relation to the vehicle's roof.

The fixing device described in the third document mentioned above doesn't pose said drawback only thanks to the fact that said fixing element has the shape of a parallelepiped, which prevents its rotation inside the opening made in the vehicle's roof.

The present invention aims to overcome the drawbacks listed above.

In particular, it is the object of the invention to provide a fixing device that makes it possible to lock the antenna on the roof of a vehicle by working exclusively from the outside, with no need to intervene also from the inside.

A second object of the invention is to provide a fixing element for antennas that makes it possible to lock the antenna permanently both in the direction of the axis orthogonal to the vehicle's roof and according to the rotation directions of the antenna in relation to the roof.

A further object of the invention is to provide a fixing device that guarantees better electrical continuity between the antenna and the vehicle's roof and more stability compared to the fixing devices of the known art.

Another object of the invention is to provide a fixing device for antennas that is simple to construct and can be applied with straightforward and intuitive operations, without using specific tools, and that at the same time allows the antenna to be fixed in a stable and permanent manner.

It is a further yet not the least object of the invention to provide a fixing device that makes it simpler to remove the antenna from the vehicle's roof, with no need to use special tools, compared to the fixing devices of the known art.

The objects described above are achieved by a fixing device having the characteristics illustrated in the main claim.

The invention includes also the method for fixing an antenna by means of the fixing device that is the subject of the invention.

Further characteristics of the fixing device that is the subject of the invention are described in the dependent claims.

Advantageously, the fixing device that is the subject of the invention makes it possible to reduce the time required for assembling an antenna on a vehicle's roof and to reduce the number of staff required for this operation.

Still advantageously, thanks to the fixing device of the invention it is also easier to remove the antenna from the vehicle's roof.

A further advantage is represented by the fact that the fixing device of the invention is made up of a limited number of components, which also makes it easier and more economical to manufacture.

The aforesaid objects and advantages, and others that will be described in greater detail below, will be highlighted in the description of preferred embodiments of the invention, provided here as non-limiting examples, with reference to the attached drawings, wherein:

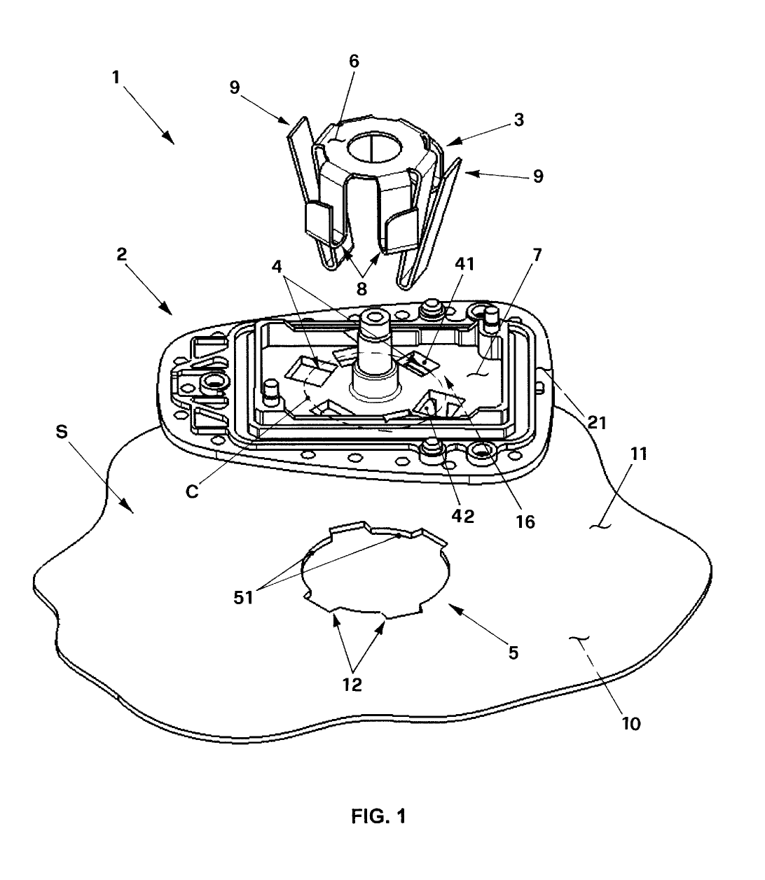

FIG. 1 is an exploded axonometric view of the fixing device carried out according to the invention;

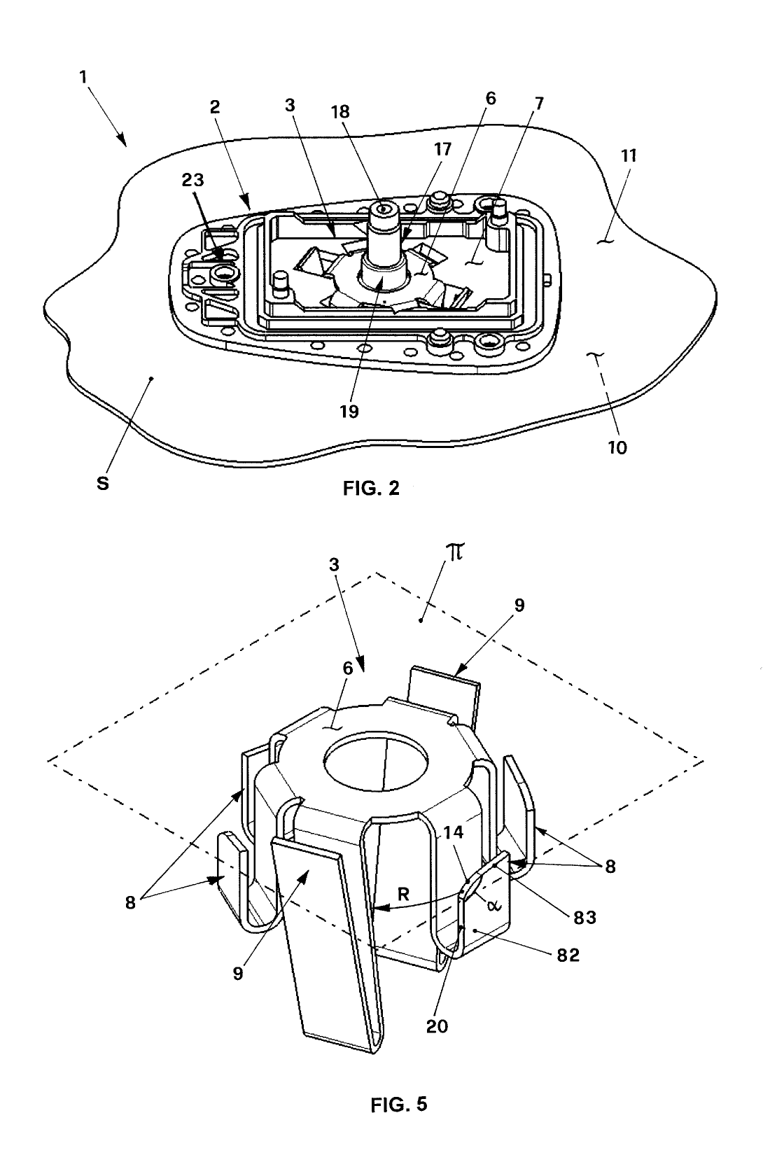

FIG. 2 is an axonometric view of the fixing device carried out according to the invention;

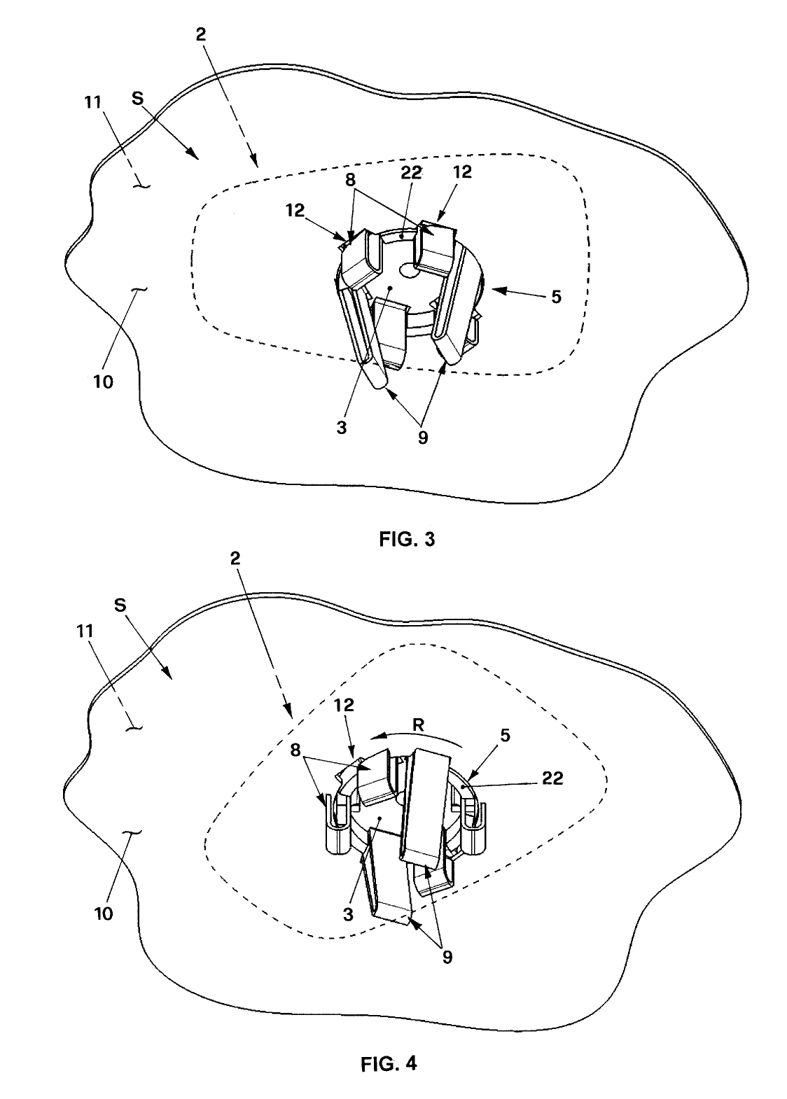

FIGS. 3 and 4 show operations b and c of the method for assembling an antenna by means of the fixing device of the invention;

FIG. 5 is an axonometric view of the fixing element belonging to the fixing device that is the subject of the invention;

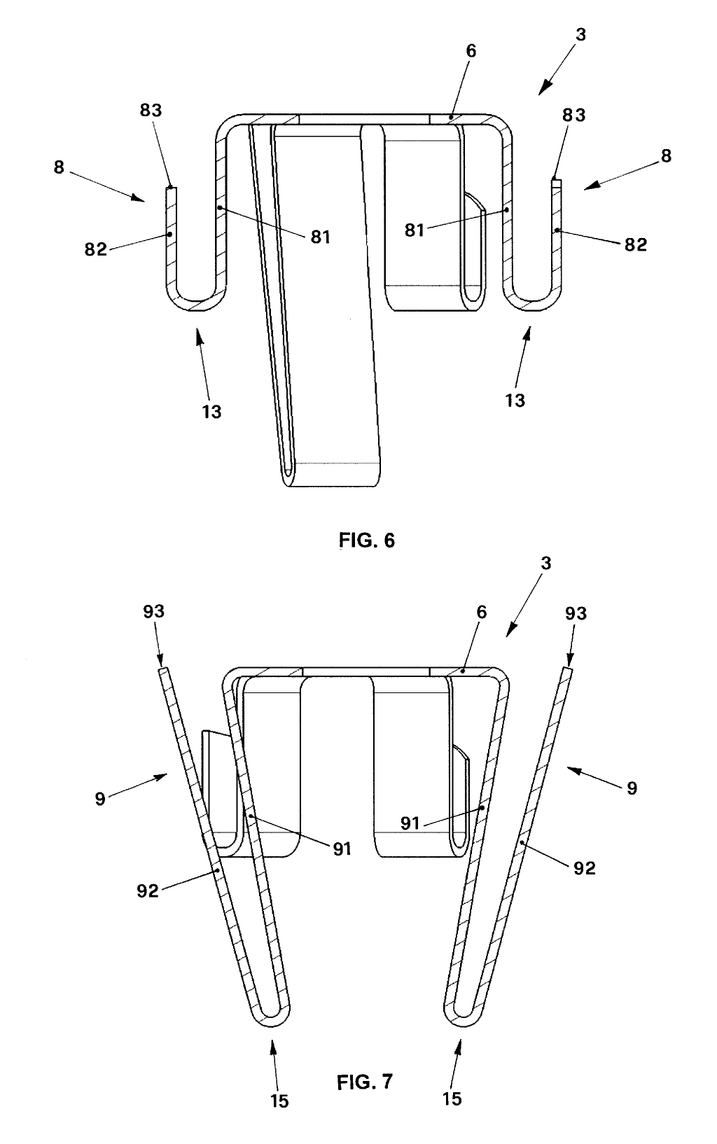

FIGS. 6 and 7 respectively show a cross sectional view of the elastic tabs of the first set and of the elastic tabs of the second set, all belonging to the fixing element;

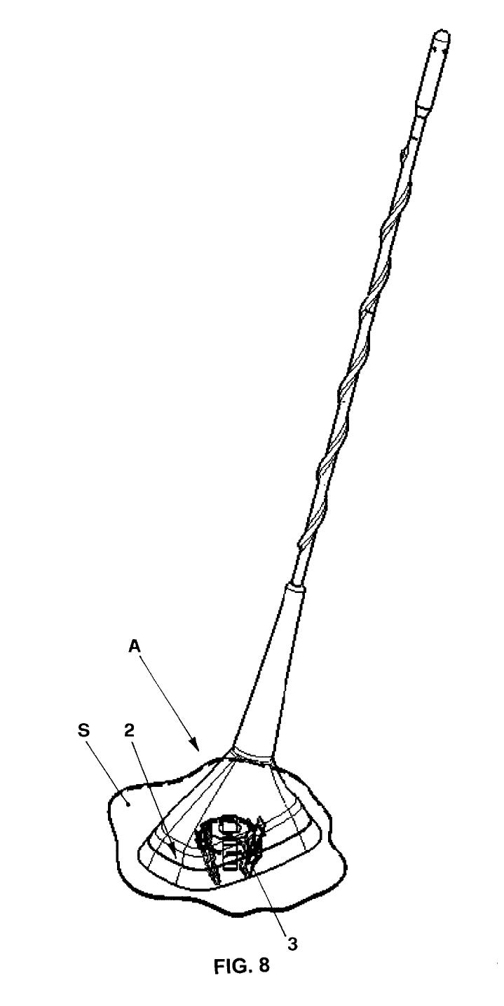

FIG. 8 shows an antenna installed on the roof of a vehicle by means of the fixing device that is the subject of the invention.

The fixing device that is the subject of the invention is shown in its whole in FIGS. 1 and 2, where it is indicated by 1.

It can be observed that the fixing device 1 of the invention is particularly suitable for permanently locking an antenna A on a supporting surface S, for example the roof of the motor vehicle, as shown in FIG. 8.

As shown in FIG. 1, the fixing device 1 comprises a base plate 2 resting on said supporting surface S and also a fixing element 3 that communicates with an underlying opening 5 made in the supporting surface S in such a way as to lock the entire antenna A to the roof of the vehicle.

In particular, as shown in FIG. 5, the fixing element 3 comprises a first and a second set of elastic tabs 8 and 9 that make it possible to lock the base plate 2 to the supporting surface S through the thrusting action of the first set of elastic tabs 8 against the wall 10 of the supporting surface S, opposite the wall 11 that supports the base plate 2, and through the insertion of the second set of elastic tabs 9 in a plurality of recesses 12 present on the edge of said opening 5.

The locking action is obtained when the first and the second set of elastic tabs 8 and 9 are inserted through the opening 5 in the supporting surface S and successively when the base plate 2 is moved in relation to the same supporting surface S.

In the particular embodiment of the invention described herein and illustrated in the figures, the fixing element 3 is separate from the base plate 2 and comprises a flange 6 from which the above mentioned first and second set of elastic tabs 8 and 9 develop.

Said flange 6 is arranged so that it rests on the same base plate 2 at the level of the wall 7, opposing the supporting surface S.

For this reason the fixing element 3 cooperates with a plurality of holes 4 made in the base plate 2 so that the first and the second set of elastic tabs 8 and 9 are inserted in said holes 4 and are successively arranged at the level of the is wall 21 of the same base plate 2, opposite the wall 7.

In a different embodiment of the invention not described herein, the fixing element 3, in particular its flange 6, could be permanently connected to the base plate 2 at the level of the wall 21 via generic locking means.

In this case, the presence of the plurality of holes 4 would not be indispensable, since the first and the second set of elastic tabs 8 and 9 are already facing towards the opening 5.

In a further embodiment of the invention, the fixing device 1 of the invention may consist of a single body in which it is possible to identify a base plate 2 with a fixing element 3 developing at the level of the wall 21, said fixing element 3 comprising a first and a second set of elastic tabs 8 and 9.

According to this embodiment, therefore, the fixing element 3 doesn't include a flange 6 resting on the base plate 2.

Going back to the particular embodiment described herein, the flange 6 of the fixing element 3, as shown in FIG. 5, has a substantially circular perimeter from which said first and said second set of elastic tabs 8 and 9 extend.

In particular, each elastic tab of the first set of elastic tabs 8 has a substantially V-shaped profile whose rounded vertex 13 upon assembly faces towards the opening 5 made in the supporting surface S, as shown in FIG. 6. Said elastic tabs 8 include a first branch 81 connected to the flange 6 and a second branch 82 having a free end 83, shorter than said first branch 81.

Furthermore, as shown in FIG. 6, the second branch 82 of each tab of the first set of elastic tabs 8 projects from the perimeter of the flange 6.

The free end 83 of said second branch 82 is inclined with respect to the plane π where the flange 6 lies, as can be seen in FIG. 5.

In particular, the free end 83 of the second branch 82 of these elastic tabs 8 defines, with one of the two side edges 20, an obtuse angle α whose vertex 14 faces towards the rotation direction R of the fixing element 3 in relation to the supporting surface S, as indicated by the arrow in FIG. 5 and as will be described in detail below.

Regarding the elastic tabs belonging to the second set of elastic tabs 9, in the embodiment described herein, and as can be observed in FIG. 7, they have a V-shaped profile, too, with rounded vertex 15 facing towards the opening 5 made in the supporting surface S.

Furthermore, as in the tabs of the first series 8, also in the tabs of the second series 9 it is possible to observe the presence of a first branch 91 connected to the flange 6 and of a second branch 92 projecting from the perimeter of the flange and having a free end 93.

Differently from the previous case, however, the second branch 92 of the second set of elastic tabs 9 is at least as long as the second branch 82 of the first set of elastic tabs 8, so that its free end 93 is constrained by one hole of the plurality of holes 4 made in the base plate 2, as shown in FIG. 2 and as will be better described below.

In different embodiments of the invention, not described and not illustrated herein, the second set of elastic tabs 9 may not develop directly from the flange 6 but starting from the first branch 81 or from the second branch 82 of each one of the elastic tabs of the first set of elastic tabs 8, and have a substantially L-shaped profile so that the free end 93 faces towards the base plate 2, as in the embodiment described above.

According to the invention, in all the embodiments of the fixing device 1 of the invention each elastic tab belonging to the second set of elastic tabs 9 must be preceded by at least one elastic tab of the first set 8 according to a specific shifting direction of the base plate 2 on the supporting surface S, which in the first embodiment described and illustrated herein coincides with the above mentioned rotation direction R, indicated by the arrow in FIG. 5.

The reason for the above will be explained in detail in the description of the method 100 for assembling the antenna A by means of the fixing device 1 that is the subject of the invention.

In the particular embodiment of the invention described herein, each elastic tab of the second set 9 is preceded by two elastic tabs belonging to the first set 8.

In particular, as shown in FIG. 5, in the embodiment described herein the fixing element 3 has two elastic tabs of the second set of elastic tabs 9, which are separated from each other, in each one of the two directions, by two tabs belonging to the first set of elastic tabs 8.

In different embodiments of the invention there may be a single elastic tab of the first set 8 preceding each elastic tab of the second set of elastic tabs 9.

In further construction variants of the invention there may be more than two elastic tabs of the first set 8 preceding each elastic tab of the second set 9.

In general, there may be a number of elastic tabs of the second set 9 different from two and, consequently, a number of elastic tabs belonging to the first set of elastic tabs 8 different from four.

In order to guarantee the coupling action, there absolutely must be at least one pair made up of one elastic tab of the second set 9 followed, in the specific shifting direction of the above mentioned base plate 2 on the supporting surface S, by one tab belonging to the first set of elastic tabs 8.

The plurality of holes 4 in the base plate 2, as shown in FIG. 1, is made along a circumference C whose radius is at least as long as the radius of the flange 6, so that the first and the second set of elastic tabs 8 and 9 can be comfortably inserted therein.

In particular, the plurality of holes 4 comprises first holes 41 suited to accommodate the first set of elastic tabs 8 and second holes 42 for the insertion of the elastic tabs belonging to the second set 9.

As shown in FIG. 1, the first holes 41 are narrower than the second holes 42 and in this way each tab of the first set of elastic tabs 8 is compressed when inserted through them and returns to its natural position when it has passed through the same holes 41.

This characteristic allows each tab of the first set of elastic tabs 8 to stop, even if temporarily, the movement of the fixing element 3 on the base plate 2 in relation to the direction orthogonal to the plate itself.

In a different way, the second branch 92 of each elastic tab belonging to the second set of elastic tabs 9, as previously mentioned, is constrained inside each one of the second holes 42 so as to prevent the rotation of the fixing element 3 on the base plate 2, as shown in FIG. 1.

In the embodiment described herein, on the wall 21 of the base plate 2 resting on the supporting surface S and, in particular, at the level of each one of said first holes 41, there is a first projecting element 16 that thrusts against the free end 83 of each elastic tab belonging to the first set of elastic tabs 8, when the fixing element 3 is inserted in the base plate 2.

In different construction variants, said projecting elements 16 may also be absent, provided that the free end 83 of the elastic tabs of the first set 8 thrusts against the supporting surface S, thus locking the base plate 2 onto it.

Always on the wall 21 of the base plate 2, at the level of the arcs of the circle C that are not provided with the plurality of holes 4, there are second projecting elements 22, as can be seen in FIG. 3, suited to thrust against the edge 51 of the opening 5 at the moment when the base plate 2 rests on the supporting surface S.

The presence of said second projecting elements 22 prevents the entire fixing device 1 of the invention from being subjected to slight changes in position in relation to the supporting surface S due to any possible play between them.

As shown in FIG. 2, the base plate 2 comprises also a projection 17 at the level of the wall 7 opposite the supporting surface S.

Said projection 17 is provided with a hole 18 allowing the passage of the electric connections, not illustrated herein, between the antenna A and the inside of the motor vehicle.

In the construction variant described and illustrated herein the projection 17 is cylindrical in shape.

Obviously, the fixing element 3, in order to be able to be coupled with the base plate 2, must be provided, on the flange 6, with a hole 19 whose perimeter coincides with the profile of the projection 17 in such a way as to allow the passage of the electric connections in the whole fixing device 1, as shown in FIG. 2.

Finally, in the particular embodiment described herein and illustrated in FIG. 1, the opening 5 made in the supporting surface S has a profile whose perimeter is defined by a plurality of arcs of a circle 51 spaced from each other by the plurality of recesses 12.

In particular, the number of recesses 12 provided on the edge of the opening 5 coincides with the number of elastic tabs belonging to the first set of elastic tabs 8, as will be explained in detail in the description of the method 100 for assembling the antenna A by means of the fixing device 1 of the invention.

In the embodiment described herein, and as shown in FIG. 2, the means 23 for positioning the circuitry that make up the antenna A are provided on the wall 7 of the base plate 2.

In different embodiments of the invention said positioning means 23 can be provided directly on the flange 6 of the fixing element 3, in order to meet specific design needs.

According to a second embodiment of the invention, the flange 6 of the fixing element 3 may have a rectangular profile.

In this case the elastic tabs belonging to both the first and the second set of elastic tabs 8 and 9 develop exclusively at the level of one pair of parallel sides of the above mentioned profile, as will be explained in detail here below.

Consequently, in this embodiment also the plurality of holes 4 must be made in the base plate 2 along a rectangular perimeter that substantially coincides with the perimeter of the above mentioned flange 6.

Finally, the opening 5 made in the supporting surface S must in turn have a rectangular profile, wherein the plurality of recesses 12 is present exclusively on one pair of parallel sides, in such a way as to accommodate, without compressing them, all the tabs of the first set of elastic tabs 8 present on the fixing element 3, when the base plate 2 is placed on the supporting surface S.

Furthermore, the two sides of the opening 5 that are not provided with the plurality of recesses 12 are substantially as long as the two sides of the flange 6 where no tab is provided.

On the contrary, the sides of the opening 5 that are provided with the plurality of recesses 12 must be longer than the sides of the flange 6 where there are the tabs of both the first and the second set of elastic tabs 8 and 9.

In particular, said length must exceed the length of the side of the flange 6 by at least the width of an elastic tab belonging to the first set 8.

The reason for this need will be explained in detail in the description of the fixing method 100 with reference to this second embodiment of the invention.

To conclude the description of the above mentioned second embodiment, it should be noted that if the size of the base plate 2 is excessive compared to the size of the fixing device 1 that is the subject of the invention, the latter alone may not be sufficient to ensure the proper locking of the antenna A to the supporting surface S.

Therefore, it would be necessary to provide a further element suited to ensure the coupling on the above mentioned wall 21, and said element could, for example, have a substantially L-shaped profile.

In this case, it is necessary to make a further opening in the supporting surface S in order to allow said coupling element to be inserted when the base plate 2 is placed on the supporting surface S.

The profile of said second opening should not be smaller than the base of the coupling element inserted therein.

Also the reasons for this particular structure will be clarified in the description of the method for assembling an antenna A with reference to the second embodiment of the fixing device.

As is evident from the description of the elements making up the fixing device 1 of the invention, also the method 100 for assembling an antenna A by means of the above mentioned fixing device 1 appears to be innovative.

In particular, the method 100 for assembling an antenna A by means of the fixing device 1 of the invention includes the operations described here below.

In the case of the embodiment described and illustrated herein, where the fixing element 3 is separate from the base plate 2, the first operation serves to arrange the fixing element 3 on the base plate 2, inserting each elastic tab of the first and second sets 8 and 9 in the corresponding holes 41 and 42, as shown in FIG. 2.

In further detail, as already mentioned, when the elastic tabs of the first set of elastic tabs 8 are inserted in the first holes 41, they are compressed and then return to their original position once they have passed through the hole 41, thanks to the fact that the second branch 82 is shorter than the first branch 81. Said coupling makes it possible to stop the movement of the fixing element 3 on the base plate 2 with respect to the direction orthogonal to the same base plate 2 and prevents said fixing element 3 from coming off.

As regards the elastic tabs belonging to the second set 9, they are inserted in the corresponding second holes 42 and, since the second branch 92 is at least as long as the first branch 82, are constrained therein preventing the fixing element 3 from rotating in relation to the above mentioned base plate 2.

This operation is obviously different in the embodiment in which the fixing element 3 must be constrained to the base plate at the level of the wall 21, as previously explained.

Furthermore, if the fixing device 1 of the invention is comprised of a single body, the first operation just described above must not be performed.

At this point, the first fundamental operation of said method 100, indicated by a and illustrated in FIG. 3, consists in positioning the base plate 2 together with the fixing element 3 on the supporting surface S, inserting the elastic tabs of the first set of elastic tabs 8 in the corresponding recesses 12 present on the edge of the opening 5.

As regards, instead, the elastic tabs of the second set 9, as shown in FIG. 3 they are compressed and thrust against the edge of the opening 5, remaining in the same position also when the above mentioned base plate 2 rests completely on the supporting surface S.

In the case of the first embodiment described above, in which both the flange 6 and the opening 5 have a substantially circular profile, in order to fix the antenna A definitively by means of the fixing device 1 of the invention it is necessary to perform the second operation b, according to which the base plate 2 is rotated together with the fixing element 3 in the rotation direction R previously defined, as shown in FIG. 4.

In practice, it is necessary to rotate the antenna A towards the side where the free end 83 together with a side edge 20 of the second branch 82 of each elastic tab belonging to the first set 8 defines an obtuse angle α.

During this operation two conditions are obtained, which are indispensable for fixing the antenna A in a stable and long-lasting manner.

The first condition that is obtained following the rotation lies in that the inclined free end 83 of the tabs belonging to the first set of elastic tabs 8 and the corresponding projecting element 16 pass beyond the recess 12 and thrust against the supporting surface S on opposite sides, preventing the movement of the antenna A in the direction orthogonal to the above mentioned supporting surface S.

In particular, the presence of the inclined free end 83 makes it possible to rotate the base plate 2 together with the fixing element 3, until the free end 83 is permanently locked due to friction against the supporting surface S.

The second indispensable condition that occurs during the above mentioned rotation lies in that each elastic tab of the second set 9, preceded by at least one tab belonging to the first set of elastic tabs 8 according to the above mentioned rotation direction R, is positioned inside a recess 12, partially regaining its original extension, as shown in FIG. 4.

In this way, each elastic tab belonging to the second set 9 is constrained by a recess 12, thus making it impossible to rotate the antenna A together with the fixing device 1 of the invention in relation to the supporting surface S.

In the case of the second embodiment, where both the flange 6 and the opening 5 have a substantially rectangular profile, the operation b, instead of including the rotation of the base plate 2 with respect to the supporting surface S, includes the translation of the same base plate 2 in the direction in which the opening 5 in the supporting surface S is larger than the flange 6, as previously explained.

Also in this case the free ends 83 of the tabs of the first set of elastic tabs 8 thrust against the supporting surface S and the elastic tabs of the second set 9 are positioned inside a recess 12, partially regaining their original extension and preventing the translation movement just performed.

Furthermore, in this second embodiment, in the case where the size of the base plate 2 is such that the fixing device 1 alone would not be sufficient to lock the whole antenna A on the supporting surface S, as already explained above it is possible to add a further coupling element with substantially L-shaped profile, suited to be introduced in a further opening made in the same supporting surface S.

When the entire base plate is translated on the above mentioned supporting surface S, the base of said coupling element thrusts against the wall 10, like the free ends 83, to lock the vertical movement of the antenna A on the supporting surface S in the area around said coupling element.

In the description of the assembly method 100 the operation for assembling the radiofrequency antenna A on the fixing device 1 of the invention has been omitted.

Said assembly must obviously be carried out preferably but not necessarily before the operation indicated by a of the same method 100.

As already explained, in both the embodiments of the fixing device 1 described above also the removal of the antenna A from the supporting surface S is simpler.

In fact, the operations of the removal method include the compression, from the inside of the vehicle, of the elastic tabs belonging to the second set 9 and successively the rotation or translation, depending on the embodiment, of the same antenna A in the direction contrary to the movement carried out during assembly.

This makes it possible to release the antenna A from the supporting surface S and to withdraw it from the same surface.

As can be noticed, said removal technique does not require the use of any specific tool, making the operation quick and intuitive.

According to the above, therefore, it is clear that the fixing device 1 of the invention and the method 100 for assembling an antenna A by means of the fixing device 1 of the invention achieve all the set objects.

In particular, the invention achieves the object to provide a fixing device that makes it possible to lock the antenna to the roof of a vehicle by working exclusively from the outside, with no need to intervene also from the inside.

The invention also achieves the object to provide a fixing device for antennas that makes it possible to permanently lock the above mentioned antenna both in the direction of the axis orthogonal to the roof of the vehicle and in the rotation directions of the antenna with respect to the roof.

The invention also achieves the object to provide a fixing device that guarantees better electrical continuity between the antenna and the roof of the vehicle and more stability compared to the fixing devices of the known art.

The invention also achieves the object to provide a fixing device for antennas that is simple to construct and can be applied with straightforward and intuitive operations, without using specific tools, and that at the same time allows the antenna to be fixed in a stable and permanent manner.

The invention also achieves the further object to provide a fixing device that makes it easier to remove the antenna from the roof of the vehicle compared to the fixing devices of the known art, and with no need to use specific tools.

On implementation, the fixing device and the assembly method that are the subjects of the invention may undergo changes that, though not illustrated or described herein, shall nonetheless be covered by the present patent, provided that they come within the scope of the claims that follow.

In the cases where the technical characteristics illustrated in the claims are followed by references, these have been added only with the aim to facilitate the comprehension of the claims themselves and therefore said references do not have any limiting effect on the degree of protection to be granted to each element they identify only by way of example.

1) Fixing device of an antenna to a supporting surface comprising a base plate suited to rest on said supporting surface and a fixing element communicating with an underlying opening made in said supporting surface, wherein said fixing element is provided with a first and a second set of projecting elastic tabs suited to lock said base plate to said supporting surface, through the thrusting action of said first set of elastic tabs against the wall of said supporting surface opposite the wall that supports said base plate and the insertion of said second set of elastic tabs in a plurality of recesses present on the edge of said opening when said first and said second set of elastic tabs are housed in said opening, for inserting and following moving of said base plate on said supporting surface.

2) Fixing device according to claim 1), wherein said fixing element is separate from said base plate and it comprises a flange suited to rest on said base plate, said fixing element being provided with said first and said second set of elastic tabs cooperating with a plurality of holes made in said base plate.

3) Fixing device according to claim 2), wherein said flange has a substantially circular perimeter wherein said plurality of holes are made in said base plate along the circumference of a circle whose radius is at least as long as the radius of said flange.

4) Fixing device according to claim 2), wherein each elastic tab of said first set of elastic tabs has a substantially V-shaped profile with rounded vertex facing towards said opening and comprises a first branch connected to said flange and a second branch with a free end, which is shorter than said first branch and projects from the perimeter of said flange.

5) Fixing device according to claim 4), wherein said free end of said second branch of each elastic tab of said first set of elastic tabs is inclined in relation to the plane on which said flange lies.

6) Fixing device according to claim 5), wherein said inclined free end, together with a lateral edge of said second branch of said elastic tab, defines an obtuse angle with its vertex facing towards the rotation direction of said fixing element in relation to said supporting surface.

7) Fixing device according to claim 2), wherein each elastic tab of said second set of elastic tabs has a substantially V-shaped profile with rounded vertex facing towards said opening and comprises a first branch connected to said flange and a second branch, with free end, which is at least as long as said first branch and projects from the perimeter of said flange.

8) Fixing device according to claim 6), wherein each elastic tab of said second set of elastic tabs is preceded by at least one elastic tab of said first set of elastic tabs according to said rotation direction.

9) Fixing device according to claim 1), wherein said plurality of holes made in said base plate comprises first holes suited to house said first set of elastic tabs and second holes suited to house said second set of elastic tabs, said first holes being narrower than said second holes, so that each elastic tab of said first set of elastic tabs is compressed when it is inserted in one of said first holes and returns to its natural position once it has passed through said first hole.

10) Fixing device according to claim 1), wherein said opening has a profile whose perimeter is defined by a plurality of arcs of circles spaced from one another by a number of recesses of said plurality of recesses that is equal to the number of elastic tabs of said first set of elastic tabs.

11) Method for assembling an antenna by means of a fixing device with characteristics according to claim 1), wherein it comprises the following operations:
a) arranging said base plate together with said fixing element on said supporting surface, so that each elastic tab of said first set of elastic tabs is inserted in said recesses and that each elastic tab of said second set of elastic tabs is compressed by the edge of said opening of said supporting surface;
b) moving said base plate together with said fixing element on said supporting surface, so that said free end, inclined at the level of said second branch, of each elastic tab of said first set of elastic tabs exerts a thrusting action against the wall of said supporting surface opposite said base plate, in such a way as to lock the movement of said base plate along the direction orthogonal to said supporting surface and so that each elastic tab of said second set of elastic tabs is arranged in one of said plurality of recesses extending partially in order to lock the horizontal movement of said base plate on said supporting surface.
